(19) United States
(12) Patent Application Publication
(10) Pub. No.: US 2003/0012621 A1
(43) Pub. Date: Jan. 16, 2003

(54) Cotter clip

(76) Inventor: James Fletcher, Newmanstown, PA (US)

Correspondence Address: James Fletcher Simmermon, 108 Spring Haven Road, Newmanstown, PA, 17073, US

(21) Appl. No.: 09/901,338

(22) Filed: Jul. 10, 2001

(51) Int. Cl. F16B 21/14

(52) U.S. Cl. 411/513

(57) ABSTRACT

A cottering device for maintaining the relative position of pins, shafts and turnbuckles including a continuous wire member formed to include a straight portion ending in a resilient connecting loop ending in a generally circular portion of constant radius. The cotter clip may be installed in a bore in a pin or shaft by applying a force to the connecting loop that simultaneously displaces the apex of the generally circular portion from a common plane and causes the straight portion to be inserted into the bore. During installation the straight portion is elastically deformed about the pin or shaft and returns to a preinstalled condition when the insertion is complete. The clip is simply removed by elevating the apex above the pin or shaft and withdrawing the straight portion from the bore.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. Field of the Invention

The invention relates broadly to applications requiring cottering devices to secure pins, shafts, studs, or bolts,. More particularly, it concerns applications where the splayed ends of a conventional cotter pin would create the potential for snagging of materials, or where removal and reinsertion of a cotter pin may be required in the course of routine maintenance or adjustment.

2. Description of the Prior Art

Conventional cotter pins have long been in use to secure clevis pins and, on sailing vessels, to maintain the position of open body turnbuckles relative to the rigging members to which they are attached. Most turnbuckles are of the open body type allowing ease of adjustment and inspection. The standard practice is to tension all standing rigging to the appropriate specifications then secure the turnbuckles in position by the use of cotter pins. The cotter pin is inserted through a hole in the end of the stud which is visible and accessible within the open body of the turnbuckle. It is then secured in the stud by spreading the ends of the pin. The protruding head of the cotter pin, when in contact with the side of the turnbuckle body, prevents relative rotation of the stud. To prevent snagging and damage to sails, lines, and personnel the sharp bent ends of the cotter pin are concealed beneath multiple layers of tape.

The practice of using cotter pins and tape to effect the required seizing of the turnbuckles and clevis pins presents several opportunities for improvement. The problems encountered with the cotter pin and tape method include the rapid degradation of the tape, the entrapment of corrosive salt, and the inability to retension the standing rigging quickly and easily. Also, there is an inherent liability in the normal practice of reusing cotter pins. The splayed ends of the cotter pins, once bent and straightened, are prone to fatigue and may break off after repeated installations.

### BRIEF SUMMARY OF THE PRESENT INVENTION

The present invention is simply constructed, easily installed, and self locking to prevent its being dislodged either by the components it secures or by external interferences. The cotter clip is formed of a singular elongated member of resilient wire-like material such as stainless steel shaped into a form comprised essentially of three sections. This first section is a straight portion which forms the locking component of the clip and which continues from its extremity to form a small somewhat circular section used to grip the clip for the purpose of installation and also the extension of which restricts rotation of the clip and secured shaft when in contact with another body. Following on from the small circular section is a larger somewhat circular portion having a slight apex immediately opposite the beginhing extremiity of the straight section previously described. The larger circular section conforms to the external surface of the secured shaft or stud.

Installation of the cotter clip described above is accomplished in a quick and simple operation without the use of a tool by gripping the clip by the resilient ring 6 and inserting the straight locking portion 1 into the bore of the element to be secured. The securing portion will slide over the circumference of the shaft 8 and move easily into the final installed position, thus holding the locking portion in the locking position and thereby securing it against unintentional release or removal. The cotter clip is flexible enough to allow insertion of the straight member into the bore of a shaft or stud without permanent bending of the clip. Removal of the clip is accomplished by raising the apex on the large securing portion of the clip to a position above the top of the shaft. The clip may then be easily extracted by sliding the locking portion out from the bore of the shaft. The clip may be installed and removed repeatedly without affecting the integrity of the clip.

### BRIEF DESCRIPTION OF THE DRAWINGS

FIG. 1 is a plan view of the cotter clip;

FIG. 2 is a plan view of the cotter clip shown as fully inserted and locked into a clevis pin;

FIG. 3 is an elevation of the clip showing the method of initial insertion into a clevis pin.

### DETAILED DESCRIPTION OF THE INVENTION

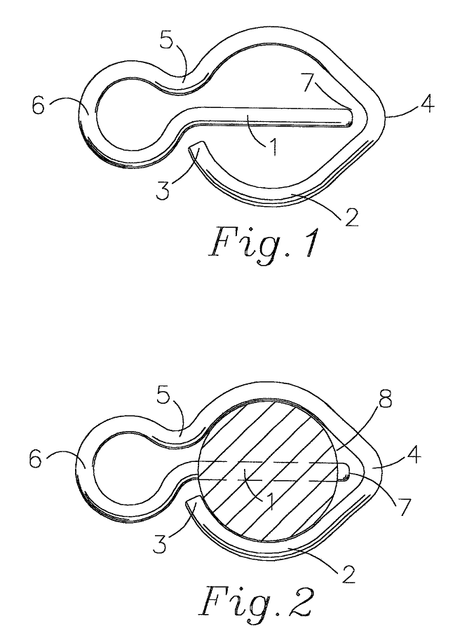

Referring to FIG. 1 there is shown a cottering device comprised of a singular length of resilient material such as spring steel or plastic having a circular cross section throughout its length and molded or bent from a straight section 1 into a minor ring portion 6 and continuing through at least 280 degrees of arc to an arc of opposite center 5 for 95 degrees then forming a major ring 2 for at least 310 degrees and terminating at a point 3. In the embodiment shown by FIG. 1 there is included 4, an apex outward of the major ring for a distance of several wire diameters opposite the diametrical center line of the terminus 7 of the straight portion 1 of the cotter clip.

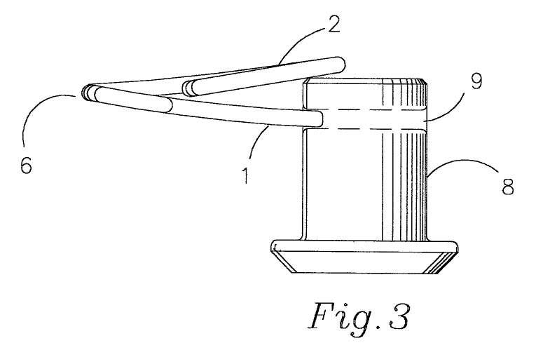

Referring specifically to FIG. 1, 7 is the terminus of the straight section of the clip intended to be inserted in the bore of a shaft or stud. 6 is the minor ring extending outward from the major ring 2 for the purpose of intentionally contacting the lateral body of a turnbuckle to prevent rotation of said shaft or stud. The protrusion 4 is an aid in insertion and removal of the clip and protects the terminus 7 when fully installed as shown in FIG. 2.

FIG. 3 is an elevation representing the cotter clip of FIG. 1 in a position of partial insertion into the bore 9 of the clevis pin 8. The major ring 2 is elastically displaced from the original common plane of the uninstalled clip to allow the cotter clip to advance to the right as shown in FIG. 3 to a position over the end of the clevis pin. The inside diameter of the major ring 2 being greater than the outer diameter of the pin 8, the cotter clip will return to its planar form upon full insertion of section 1 into bore 9.

What I claim as my invention is:

1. A locking clip for securing the relative position of elements on clevis pins, bored shafts, and turnbuckle and stud assemblies comprising:
A cottering device formed from a single length of resilient wire-like material with a first generally straight section commencing at a first end and terminating in a resilient connecting loop which itself terminates in a generally circular portion formed to describe the periphery of said shaft with said circular portion having an apex formed from the circular portion at a position diametrically opposite said first end and continuing to a second end at a point some 300 degrees from the termination of said connecting loop.
